(19) United States
(12) Patent Application Publication
(10) Pub. No.: US 2018/0341974 A1
(43) Pub. Date: Nov. 29, 2018

(54) ACCOUNTING FOR USER INTERACTION WITH CONTENT ASSOCIATED WITH CONTENT ITEMS PRESENTED BY AN ONLINE SYSTEM WHEN SELECTING CONTENT ITEMS FOR PRESENTATION BY THE ONLINE SYSTEM

(71) Applicant: Facebook, Inc., Menlo Park, CA (US)

(72) Inventors: Junfeng Pan, Santa Clara, CA (US); Tyler Paul Sax, Oakland, CA (US); Yining Wu, Sunnyvale, CA (US); Yili Zhao, Burlingame, CA (US); Dihong Gao, Union City, CA (US); Juanjuan Xu, Cupertino, CA (US); Xiaojun Liang, San Jose, CA (US); Asad K. Awan, San Francisco, CA (US); Jonathan Mooser, Mountain View, CA (US); Chin Lung Fong, Foster City, CA (US); Hong Yan, Los Altos, CA (US)

(21) Appl. No.: 15/605,815

(22) Filed: May 25, 2017

(51) Int. Cl. G06Q 30/02; H04L 29/08

(52) U.S. Cl. CPC G06Q 30/0242; H04L 67/22; G06Q 30/0275; H04L 67/306; G06Q 30/0255

(57) ABSTRACT

An online system accounts for measures of quality of content items when selecting content items for presentation to users. For a content item including a link to a landing page outside a domain of the online system, the measure of quality accounts for a likelihood of a user presented with the content item returning to the online system after less than a threshold amount of time accessing the landing page. The measure of quality of the content item is based on the likelihood of the user returning to the online system after less than the threshold amount of time relative to likelihoods of other users returning to the online system after less than the threshold amount of time. The measure of quality of the content item is affected by a difference between the likelihood determined for the user and the likelihoods determined for other users.

### BACKGROUND

This disclosure relates generally to recommending content to online system users, and more specifically to identifying content items or users for presentation to an online system user.

Online systems, such as social networking systems, allow users to connect to and to communicate with other users of the online system. Users may create profiles on an online system that are tied to their identities and include information about the users, such as interests and demographic information. The users may be individuals or entities such as corporations or charities. Online systems allow users to easily communicate and to share content with other online system users by providing content to an online system for presentation to other users. Content provided to an online system by a user may be declarative information provided by a user, status updates, check-ins to locations, images, photographs, videos, text data, or any other information a user wishes to share with additional users of the online system. An online system may also generate content for presentation to a user, such as content describing actions taken by other users on the online system.

Additionally, many online systems commonly allow publishing users (e.g., businesses) to sponsor presentation of content on an online system to gain public attention for a user's products or services or to persuade other users to take an action regarding the publishing user's products or services. Content for which the online system receives compensation in exchange for presenting to users is referred to as “sponsored content.” Many online systems receive compensation from a publishing user for presenting online system users with certain types of sponsored content provided by the publishing user. Frequently, online systems charge a publishing user for each presentation of sponsored content to an online system user or for each interaction with sponsored content by an online system user. For example, an online system receives compensation from a publishing user each time a content item provided by the publishing user is displayed to another user on the online system or each time another user is presented with a content item on the online system and interacts with the content item (e.g., selects a link included in the content item), or each time another user performs another action after being presented with the content item.

A content item provided to the online system by a publishing user for presentation to users may include a link to a landing page, which presents content from a domain external to the online system to a user who accesses the link when presented with the content item. This allows the publishing user to leverage the online system to present the content to users of the online system, increasing awareness of the content. However, users of the online system accessing the link in the content item are not aware of the content unless they are presented with the content for sufficient time to review the content. For example, if the landing page is slow to load on a client device of an online system user or is improperly presented by the client device of the online system user, the online system user is likely to become frustrated and navigate away from the landing page without reviewing the content presented by the landing page. Such presentation of the content item to users who do not interact with the landing page identified by the link in the content item may cause the publishing user to expend resources for presenting the content item via the online system that does not result in increased awareness of or interaction with the content identified by the landing page. This may discourage the publishing user from subsequently presenting other content items via the online system, limiting dissemination of content from the publishing user and compensation to the online system.

### SUMMARY

An online system receives a content item that includes content for presentation to users of the online system and a link to a landing page that is in a domain differing from a domain of the online system. For example, the link specifies a network address of a domain different from the domain of the online system, so when an online system user accesses the link via a client device presenting the content from the content item, the client device obtains content form the network address specified by the link and presents the obtained content to the online system user. In various embodiments, the landing page is an application, a web page, or any other suitable data obtained from the domain differing from the domain of the online system. The content item is received from a publishing user in various embodiments.

The content item includes a bid amount specifying an amount of monetary compensation the online system receives from the publishing user providing the content item in exchange for presenting the content item. For example, the bid amount specifies a maximum amount of compensation the publishing user provides the online system if content in the content item is presented to a user, if the content in the content item receives a user interaction when presented, if a user accesses the landing page identified by the link included in the content item, or if any suitable condition is satisfied when content in the content item is presented to a user. For example, the bid amount included in a content item specifies a monetary amount that the online system receives from the publishing user if content in the content item is displayed.

However, an online system user's experience after selecting the link in the content item affects the performance of the content item for the publishing user. For example, if the landing page is slow to be retrieved and presented to the online system user who selected the link, the online system user is more likely to navigate away from the landing page without fully viewing content presented by the landing page. As another example, if the landing page is improperly formatted for presentation by a client device of a user who selected the link in the content item, the user is more likely to navigate away from the landing page without viewing content presented by the landing page. In another example, if the landing page presents a user who selected the link with content differing from content the user expected to view via the landing page, the user is also more likely to navigate away from the landing page without viewing content presented by the landing page. Users navigating away from the landing page without viewing content on the landing page limits effectiveness of presenting the content item via the online system, which may deter a publishing user providing the content item to the online system from providing additional content items to the online system for presentation.

To increase the likelihood of the content item's being presented to users who view content presented on the landing page identified by the link in the content item, the online system obtains a model that determines likelihoods of users of the online system who select the link included in the content item returning to the online system after being presented with the landing page for less than a threshold amount of time. Based on characteristics of a user and characteristics of the landing page, the model determines a likelihood of the user returning to the online system after being presented with the landing page for less than the threshold amount of time. In various embodiments, the model is trained based on characteristics of users who previously accessed the landing page after being presented with an additional content item or who previously accessed content having at least a threshold amount of characteristics matching or similar to characteristics of the landing page after being presented with the additional content item. The model may account for characteristics of content items presented to users before the users accessed the landing page or the content having the threshold amount of characteristics matching characteristics of the landing page when determining likelihoods of users returning to the online system after being presented with the landing page for less than the threshold amount of time. The threshold amount of time being presented with the landing page prior to returning to the online system may be specified by the publishing user and provided to the online system by the publishing user along with the content item.

By applying the obtained model to characteristics of various users and to characteristics of the content item, the online system determines likelihoods of various users returning to the online system after being presented with the landing page identified by the link included in the content item for less than the threshold amount of time. For example, the online system applies the obtained model to each user of the online system to determine a likelihood of each user returning to the online system after being presented with the landing page for less than the threshold amount of time. As another example, if the content item includes targeting criteria, the online system applies the obtained model to each online system user having characteristics satisfying at least a threshold amount of the targeting criteria to determine likelihoods of users satisfying the targeting criteria returning to the online system after being presented with the landing page for less than a threshold amount of time. Similarly, in other examples, the online system determines likelihoods of users having one or more specific characteristics (e.g., location, gender, occupation, interests, connections to an object, etc.) returning to the online system after being presented with the landing page for less than the threshold amount of time. From the likelihoods of various users returning to the online system after being presented with the landing page identified by the link included in the content item for less than the threshold amount of time, the online system determines an average likelihood of returning to the online system after being presented with the landing page for less than the threshold amount of time.

When the online system identifies an opportunity to present the content item to a viewing user, the online system applies the model to characteristics of the viewing user to determine a likelihood of the viewing user returning to the online system after being presented with the landing page for less than the threshold amount of time. Based on a comparison of the likelihood of the viewing user returning to the online system after being presented with the landing page for less than the threshold amount of time to the average likelihood of users returning to the online system after being presented with the landing page for less than the threshold amount of time, the online system determines a measure of quality of the content item to the viewing user. If the comparison indicates the likelihood of the viewing user returning to the online system after being presented with the landing page for less than the threshold amount of time is greater than the average likelihood of users returning to the online system after being presented with the landing page for less than the threshold amount of time, the measure of quality is relatively higher than if the comparison indicates the likelihood of the viewing user returning to the online system after being presented with the landing page for less than the threshold amount of time is less than the average likelihood of users returning to the online system after being presented with the landing page for less than the threshold amount of time. For example, the online system determines the measure of quality based on various criteria and decreases the measure of quality if the comparison indicates the likelihood of the viewing user returning to the online system after being presented with the landing page for less than the threshold amount of time is greater than the average likelihood of users returning to the online system after being presented with the landing page for less than the threshold amount of time. Conversely, in the preceding example, the measure of quality is increased if the comparison indicates the likelihood of the viewing user returning to the online system after being presented with the landing page for less than the threshold amount of time is less than the average likelihood of users returning to the online system after being presented with the landing page for less than the threshold amount of time.

In various embodiments, the online system determines a difference between the likelihood of the viewing user returning to the online system after being presented with the landing page for less than the threshold amount of time and the average likelihood of users returning to the online system after being presented with the landing page for less than the threshold amount of time. Based on the determined difference, the online system determines the measure of quality of the content item to the viewing user. In various embodiments, the measure of quality is inversely related to the determined difference. Hence, as the difference between the likelihood of the viewing user returning to the online system after being presented with the landing page for less than the threshold amount of time and the average likelihood of users returning to the online system after being presented with the landing page for less than the threshold amount of time increases, the measure of quality of the content item for the viewing user decreases. Conversely, as the difference between the likelihood of the viewing user returning to the online system after being presented with the landing page for less than the threshold amount of time and the average likelihood of users returning to the online system after being presented with the landing page for less than the threshold amount of time decreases, the measure of quality of the content item for the viewing user increases. If the content item includes a bid amount, the online system determines the measure of quality of the content item for the viewing user by decreasing the bid amount included in the content item if the difference is greater than a threshold value; conversely, the online system determines the measure of quality of the content item for the viewing user by increasing the bid amount included in the content item if the difference is less than the threshold value. Hence, the online system decreases the bid amount if the likelihood of the viewing user returning to the online system after being presented with the landing page for less than the threshold amount of time is greater than the average likelihood and increases the bid amount if the likelihood of the viewing user returning to the online system after being presented with the landing page for less than the threshold amount of time is less than the average likelihood.

Alternatively, when determining the measure of quality of the content item for the publishing user, the online system determines a likelihood of the viewing user not returning to the online system after being presented with the landing page for less than the threshold amount of time from the likelihood of the viewing user returning to the online system after being presented with the landing page for the threshold amount of time. The online system subtracts the likelihood of the viewing user returning to the online system after being presented with the landing page for less than the threshold amount of time from 100% to determine the likelihood of the viewing user not returning to the online system after being presented with the landing page for at least the threshold amount of time. Similarly, the online system determines an alternative average likelihood indicating a likelihood of the viewing user not returning to the online system after being presented with the landing page for less than the threshold amount of time. The online system determines the alternative average likelihood by subtracting the average likelihood of users returning to the online system after being presented with the landing page for less than the threshold amount of time from 100%.

To determine the measure of quality of the content item for the viewing user, the online system compares the likelihood of the viewing user not returning to the online system after being presented with the landing page for at least the threshold amount of time to the alternative average likelihood. If the likelihood of the viewing user not returning to the online system after being presented with the landing page for at least the threshold amount of time exceeds the alternative average likelihood, the online system increases the measure of quality of the content item to the viewing user. Conversely, if the likelihood of the viewing user not returning to the online system after being presented with the landing page for at least the threshold amount of time is less than the alternative average likelihood, the online system decreases the measure of quality of the content item for the viewing user. If the content item includes a bid amount, the online system scales the bid amount a value based on the difference between the likelihood of the viewing user not returning to the online system after being presented with the landing page for less than the threshold amount of time and the alternative average likelihood in some embodiments.

The online system includes the content item in association with its measure of quality for the viewing user in one or more selection processes that select content for presentation to the viewing user via the identified opportunity. The one or more selection processes rank content items based on their associated measures of relevance and selects content items having at least a threshold position in the ranking for presentation to the viewing user via the identified opportunity. For example, if the content item includes a bid amount, the online system modifies the bid amount based on the likelihood of the viewing user returning to the online system after being presented with the landing page for less than the threshold amount of time (or based on the likelihood of the viewing user not returning to the online system after being presented with the landing page for less than the threshold amount of time), and the one or more selection processes rank the content item based on its modified bid amounts and other content items based on their bid amounts. Accounting for the likelihood of the viewing user returning to the online system after being presented with the landing page for less than the threshold amount of time (or based on the likelihood of the viewing user not returning to the online system after being presented with the landing page for less than the threshold amount of time) affects a likelihood of the one or more selection processes selecting the content item for presentation to the viewing user. This allows the content item to be presented to users of the online system more likely to access or engage with the landing page identified by the content item, providing a greater benefit to the publishing user from presenting the content item via the online system.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is a flowchart of a method for accounting for a likelihood of a user presented with content items accessing content associated with a content item for at least a threshold amount of time when selecting content items for the user, in accordance with an embodiment.

FIG. 4 shows an example of time from presenting a content item including a landing page to an online system user as well as presenting the landing page, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

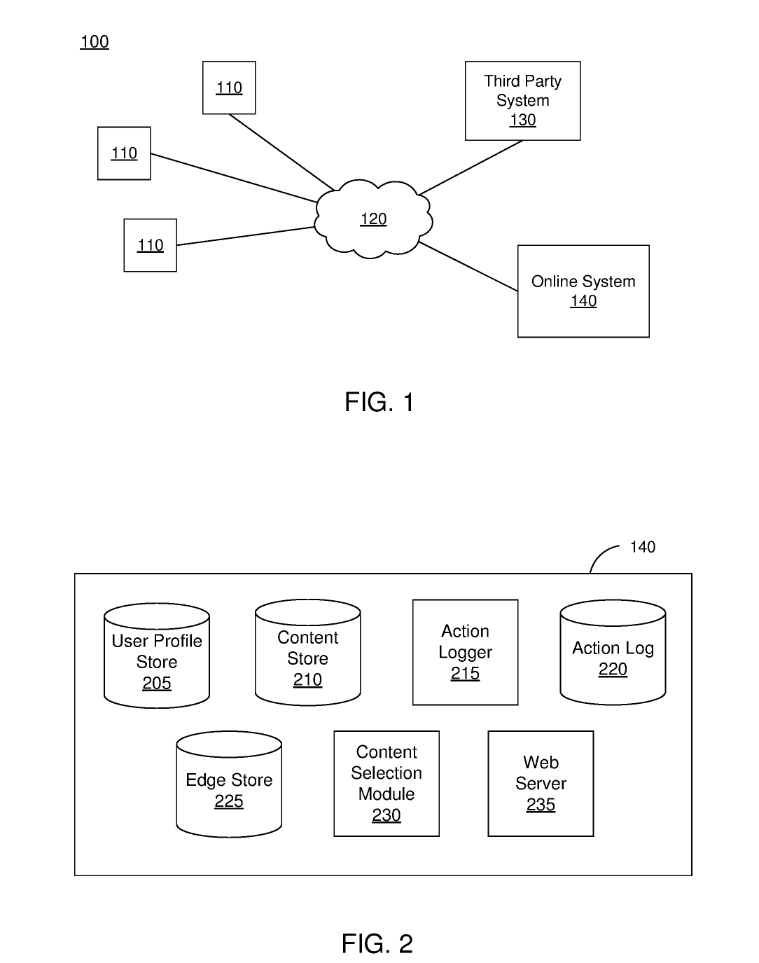

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100. For example, the online system 140 is a social networking system, a content sharing network, or another system providing content to users.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the online system 140, such as advertisements, content, or information about an application provided by the third party system 130.

FIG. 2 is a block diagram of an architecture of the online system 140. The online system 140 shown in FIG. 2 includes a user profile store 205, a content store 210, an action logger 215, an action log 220, an edge store 225, a content selection module 230, and a web server 235. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image, with information identifying the images in which a user is tagged stored in the user profile of the user. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

One or more content items included in the content store 210 include a creative, which is content for presentation to a user, and a bid amount. The creative is text, image, audio, video, or any other suitable data presented to a user. In various embodiments, the creative also specifies a page of content. For example, a content item includes a link that specifying a network address of a landing page of content to which a user is directed when the content item is accessed. If a user presented with the content The bid amount is included in a content item by a user and is used to determine an expected value, such as monetary compensation, provided by an advertiser to the online system 140 if content in the content item is presented to a user, if the content in the content item receives a user interaction when presented, or if any suitable condition is satisfied when content in the content item is presented to a user. For example, the bid amount included in a content item specifies a monetary amount that the online system 140 receives from a user who provided the content item to the online system 140 if content in the content item is displayed. In some embodiments, the expected value to the online system 140 of presenting the content from the content item may be determined by multiplying the bid amount by a probability of the content of the content item being accessed by a user.

Various content items may include an objective identifying an interaction that a user associated with a content item desires other users to perform when presented with content included in the content item. Example objectives include: installing an application associated with a content item, indicating a preference for a content item, sharing a content item with other users, interacting with an object associated with a content item, or performing any other suitable interaction. As content from a content item is presented to online system users, the online system 140 logs interactions between users presented with the content item or with objects associated with the content item. Additionally, the online system 140 receives compensation from a user associated with content item as online system users perform interactions with a content item that satisfy the objective included in the content item.

Additionally, a content item may include one or more targeting criteria specified by the user who provided the content item to the online system 140. Targeting criteria included in a content item request specify one or more characteristics of users eligible to be presented with the content item. For example, targeting criteria are used to identify users having user profile information, edges, or actions satisfying at least one of the targeting criteria. Hence, targeting criteria allow a user to identify users having specific characteristics, simplifying subsequent distribution of content to different users.

In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users that have taken a particular action, such as sent a message to another user, used an application, joined a group, left a group, joined an event, generated an event description, purchased or reviewed a product or service using an online marketplace, requested information from a third party system 130, installed an application, or performed any other suitable action. Including actions in targeting criteria allows users to further refine users eligible to be presented with content items. As another example, targeting criteria identifies users having a connection to another user or object or having a particular type of connection to another user or object.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a client device 110, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce web sites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying. Additionally, actions a user performs via an application associated with a third party system 130 and executing on a client device 110 may be communicated to the action logger 215 by the application for recordation and association with the user in the action log 220.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

An edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or user. For example, a feature may represent the level of interest that a user has in a particular topic, the rate at which the user logs into the online system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate the user's interest in an object, in a topic, or in another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The content selection module 230 selects one or more content items for communication to a client device 110 to be presented to a user. Content items eligible for presentation to the user are retrieved from the content store 210 or from another source by the content selection module 230, which selects one or more of the content items for presentation to the viewing user. A content item eligible for presentation to the user is a content item associated with at least a threshold number of targeting criteria satisfied by characteristics of the user or is a content item that is not associated with targeting criteria. In various embodiments, the content selection module 230 includes content items eligible for presentation to the user in one or more selection processes, which identify a set of content items for presentation to the user. For example, the content selection module 230 determines measures of relevance of various content items to the user based on attributes associated with the user by the online system 140 and based on the user's affinity for different content items. A measure of relevance of a content item to the user is based on a measure of quality of the content item for the user, which may be based on the creative included in the content item as well as content of a landing page identified by a link in the content item. Based on the measures of relevance, the content selection module 230 selects content items for presentation to the user. As an additional example, the content selection module 230 selects content items having the highest measures of relevance or having at least a threshold measure of relevance for presentation to the user. Alternatively, the content selection module 230 ranks content items based on their associated measures of relevance and selects content items having the highest positions in the ranking or having at least a threshold position in the ranking for presentation to the user.

Content items eligible for presentation to the user may include content items associated with bid amounts. The content selection module 230 uses the bid amounts associated with content items when selecting content for presentation to the user. In various embodiments, the content selection module 230 determines an expected value associated with various content items based on their bid amounts and selects content items associated with a maximum expected value or associated with at least a threshold expected value for presentation. An expected value associated with a content item represents an expected amount of compensation to the online system 140 for presenting the content item. For example, the expected value associated with a content item is a product of the content item's bid amount and a likelihood of the user interacting with the content item. The content selection module 230 may rank content items based on their associated bid amounts and select content items having at least a threshold position in the ranking for presentation to the user. In some embodiments, the content selection module 230 ranks both content items not associated with bid amounts and content items associated with bid amounts in a unified ranking based on bid amounts and measures of relevance associated with content items. Based on the unified ranking, the content selection module 230 selects content for presentation to the user. Selecting content items associated with bid amounts and content items not associated with bid amounts through a unified ranking is further described in U.S. patent application Ser. No. 13/545,266, filed on Jul. 10, 2012, which is hereby incorporated by reference in its entirety.

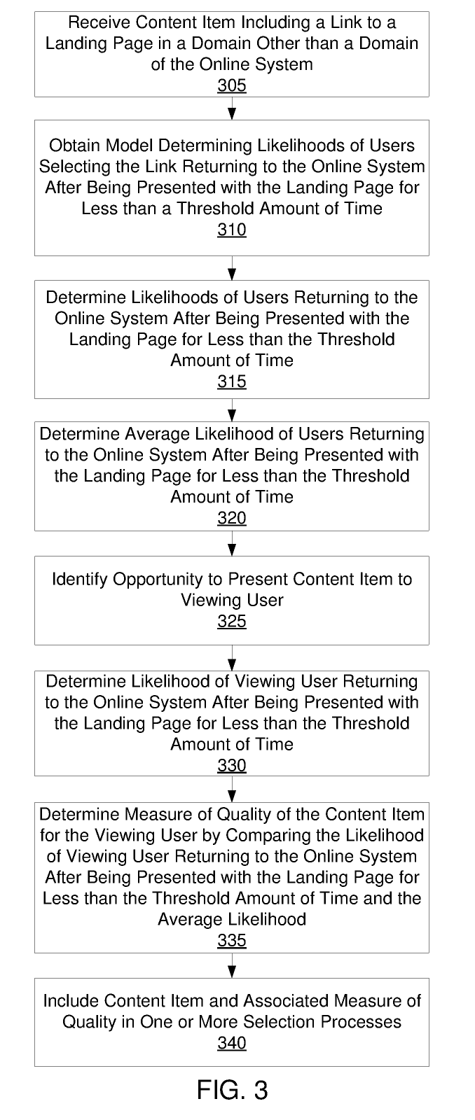

In various embodiments, the content selection module 230 determines measures of quality of content items eligible for presentation to a user via an opportunity that account for likelihoods of the user returning to the online system 140 after being presented with content from landing pages associated with content items for less than a threshold amount of time. As further described below in conjunction with FIG. 3, for a content item eligible for presentation to the user that includes a link identifying a landing page in a domain different from a domain of the social networking system, the content selection module 230 applies a model to characteristics of the user and characteristics of the landing page. The model determines a likelihood of the user returning to the online system 140 after being presented with the landing page for less than a threshold amount of time. As further described below in conjunction with FIG. 3, the content selection module 230 determines a measure of quality for a content item based on the determined likelihood, and accounts for the measure of quality in one or more selection processes selecting content for presentation to the user via the opportunity. For example, if the content item includes a bid amount, the content selection module 230 decreases the bid amount if the likelihood of the user returning to the online system 140 after being presented with the landing page for less than the threshold amount of time is greater than an average likelihood of other users returning to the online system 140 after being presented with the landing page for less than the threshold amount of time. Conversely, the content selection module 230 increases the bid amount if the likelihood of the user returning to the online system 140 after being presented with the landing page for less than the threshold amount of time is less than the average likelihood of other users returning to the online system 140 after being presented with the landing page for less than the threshold amount of time. Hence, the content selection module 230 increases a likelihood of the one or more selection processes selecting the content item if the user is less likely than other users to return to the online system 140 after being presented with the landing page for less than the threshold amount of time.

For example, the content selection module 230 receives a request to present a feed of content to a user of the online system 140. The feed includes content items such as stories describing actions associated with other online system users connected to the user. The content selection module 230 accesses one or more of the user profile store 205, the content store 210, the action log 220, and the edge store 225 to retrieve information about the user. For example, information describing actions associated with other users connected to the user or other data associated with users connected to the user are retrieved. Content items from the content store 210 are retrieved and analyzed by the content selection module 230 to identify candidate content items eligible for presentation to the user. For example, content items associated with users who not connected to the user or stories associated with users for whom the user has less than a threshold affinity are discarded as candidate content items. Based on various criteria, the content selection module 230 selects one or more of the content items identified as candidate content items for presentation to the identified user. The selected content items are included in a feed of content that is presented to the user. For example, the feed of content includes at least a threshold number of content items describing actions associated with users connected to the user via the online system 140.

In various embodiments, the content selection module 230 presents content to a user through a feed including a plurality of content items selected for presentation to the user. The content selection module 230 may also determine the order in which selected content items are presented via the feed. For example, the content selection module 230 orders content items in the feed based on likelihoods of the user interacting with various content items.

The web server 235 links the online system 140 via the network 120 to the one or more client devices 110, as well as to the one or more third party systems 130. The web server 235 serves web pages, as well as other content, such as JAVA®, FLASH®, XML and so forth. The web server 235 may receive and route messages between the online system 140 and the client device 110, for example, instant messages, queued messages (e.g., email), text messages, short message service (SMS) messages, or messages sent using any other suitable messaging technique. A user may send a request to the web server 235 to upload information (e.g., images or videos) that are stored in the content store 210. Additionally, the web server 235 may provide application programming interface (API) functionality to send data directly to native client device operating systems, such as IOS®, ANDROID™, or BlackberryOS.

Determining Likelihood of a User being Presented with Content External to the Online System for at Least a Threshold Amount of Time

FIG. 3 is a flowchart of one embodiment of a method for an online system 140 to select content items for presentation while accounting for a likelihood of a user presented with the content items accessing content associated with a content item for at least a threshold amount of time. In various embodiments, the steps described in conjunction with FIG. 3 may be performed in different orders. Additionally, in some embodiments, the method may include different and/or additional steps than those shown in FIG. 3.

The online system 140 receives 305 a content item that includes content for presentation to users of the online system 140 and a link to a landing page that is in a domain differing from a domain of the online system 140. For example, the link specifies a network address of a domain different from the domain of the online system 140, so when an online system user accesses the link via a client device 110 presenting the content from the content item, the client device 110 obtains content form the network address specified by the link and presents the obtained content to the online system user. In various embodiments, the landing page is an application, a web page, or any other suitable data obtained from the domain differing from the domain of the online system 140. The content item is received 305 from a publishing user in various embodiments.

As further described above in conjunction with FIG. 2, the content item includes a bid amount specifying an amount of monetary compensation the online system 140 receives from a publishing user providing the content item in exchange for presenting the content item. For example, the bid amount specifies a maximum amount of compensation the publishing user provides the online system 140 if content in the content item is presented to a user, if the content in the content item receives a user interaction when presented, if a user accesses the landing page identified by the link included in the content item, or if any suitable condition is satisfied when content in the content item is presented to a user. For example, the bid amount included in a content item specifies a monetary amount that the online system 140 receives from the publishing user if content in the content item is displayed.

However, an experience of an online system user after selecting the link in the content item affects the performance of the content item. For example, if the landing page is slow to be retrieved and presented to the online system user who selected the link, the online system user is more likely to navigate away from the landing page without fully viewing content presented by the landing page. As another example, if the landing page is improperly formatted for presentation by a client device 110 of a user who selected the link in the content item, the user is more likely to navigate away from the landing page without viewing content presented by the landing page. In another example, if the landing page presents a user who selected the link with content differing from content the user expected to view via the landing page, the user is also more likely to navigate away from the landing page without viewing content presented by the landing page. Users navigating away from the landing page without viewing content on the landing page limits effectiveness of presenting the content item via the online system 140, which may deter a publishing user providing the content item to the online system 140 from providing additional content items to the online system 140 for presentation.

To increase likelihoods of the content item being presented to users who view content presented on the landing page identified by the link in the content item, the online system 140 obtains 310 a model that determines likelihoods of users of the online system 140 who select the link included in the content item returning to the online system 140 after being presented with the landing page for less than a threshold amount of time. Based on characteristics of a user and characteristics of the landing page, the model determines a likelihood of the user returning to the online system 140 after being presented with the landing page for less than the threshold amount of time. In various embodiments, the model is trained based on characteristics of users who previously accessed the landing page after being presented with an additional content item or who previously accessed content having at least a threshold amount of characteristics matching or similar to characteristics of the landing page after being presented with the additional content item. The model may account for characteristics of content items presented to users before the users accessed the landing page or the content having the threshold amount of characteristics matching characteristics of the landing page when determining likelihoods of users returning to the online system 140 after being presented with the landing page for less than the threshold amount of time.

The threshold amount of time being presented with the landing page prior to returning to the online system 140 may be specified by the publishing user and provided to the online system 140 by the publishing user along with the content item. Alternatively, the online system 140 determines the threshold amount of time based on prior presentations of content from domains external to the domain of the online system 140 to users and times when users returned to the online system 140 after being presented with the content. In some embodiments, the online system 140 receives information from publishing users associated with domains external to the online system 140 indicating whether presentation of content from a domain external to the online system 140 to online system users was successful for the publishing users. Based on the received information from the publishing users associated with domains external to the online system 140 and durations that content provided by the domains external to the online system 140 presented to online system 140 were identified by the publishing users as successful, the online system 140 determines a minimum amount of time content associated with a domain external to the online system 140 is presented to users for publishing users external to the online system 140 to identify the presentation as successful. The online system 140 sets the determined minimum amount of time as the threshold amount of time. In various embodiments, the online system 140 maintains different threshold amounts of time for landing pages including different types of content. For example the online system 140 maintains a lower threshold amount of time for a landing page including greater than a threshold amount of text data, and maintains a higher threshold amount of time for a landing page including video data.

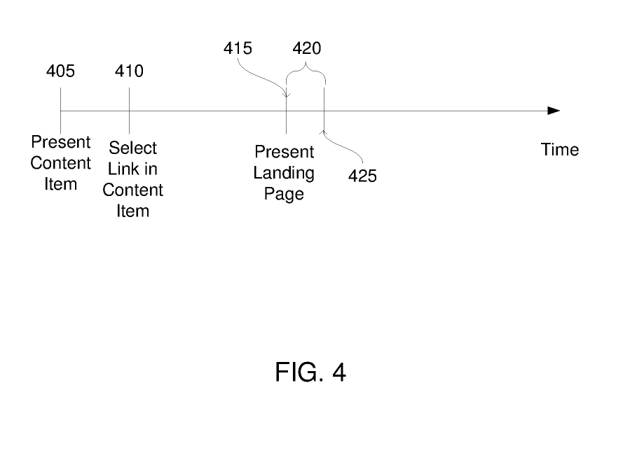

FIG. 4 shows an example of time from presenting a content item including a landing page to an online system user as well as presenting the landing page. In the example of FIG. 4, a content item including a link specifying a landing page in a domain external to the online system 140 is presented at time 405. At time 410, a user selects the link via a client device 110, causing the client device 110 to retrieve the landing page from the domain external to the online system 140 and present the landing page at time 415. If the user returns to the online system 140 during the amount of time 420 between time 415 and time 425, the user returns to the online system 140 without consuming the content presented by the landing page. Hence, if the user returns to the online system 140 after being presented with the landing page for the amount of time 420 or less, the publishing user who provided the content item does not consume the content on the landing page from the user to whom the content item was presented. However, if the user does not return to the online system 140 until after being presented with the landing page for at least the amount of time 420, the user has been exposed to the content of the landing page for a sufficient amount of time to consume the content on the landing page. Hence, the model determines a likelihood of the user returning to the online system 140 before being exposed to the content of the landing page for a sufficient amount of time to consume the content on the landing page.

Referring back to FIG. 3, by applying the obtained model to characteristics of various users and to characteristics of the content item, the online system 140 determines 315 likelihoods of various users returning to the online system 140 after being presented with the landing page identified by the link included in the content item for less than the threshold amount of time. For example, the online system 140 applies the obtained model to each user of the online system 140 to determine 315 a likelihood of each user returning to the online system 140 after being presented with the landing page for less than the threshold amount of time. As another example, if the content item includes targeting criteria, the online system 140 applies the obtained model to each online system user having characteristics satisfying at least a threshold amount of the targeting criteria to determine 315 likelihoods of users satisfying the targeting criteria returning to the online system 140 after being presented with the landing page for less than a threshold amount of time. Similarly, in other examples, the online system 140 determines 315 likelihoods of users having one or more specific characteristics (e.g., location, gender, occupation, interests, connections to an object, etc.) returning to the online system 140 after being presented with the landing page for less than the threshold amount of time.

From the likelihoods of various users returning to the online system 140 after being presented with the landing page identified by the link included in the content item for less than the threshold amount of time, the online system 140 determines 320 an average likelihood of returning to the online system 140 after being presented with the landing page for less than the threshold amount of time. For example, the online system 140 totals the determined likelihoods of returning to the online system 140 after being presented with the landing page identified by the link included in the content item for less than the threshold amount of time and divides the total of the determined likelihoods by a number of users for whom the likelihoods were determined to determine 320 the average likelihood. As another example, the online system 140 determines 320 the average likelihood as a median of the determined likelihoods. The online system 140 stores the average likelihood in association with the content item.

When the online system 140 identifies 325 an opportunity to present the content item to a viewing user, the online system 140 applies the model to characteristics of the viewing user to determine 330 a likelihood of the viewing user returning to the online system 140 after being presented with the landing page for less than the threshold amount of time. For example, the online system 140 receives a request for content form a client device 110 associated with the viewing user and determines 330 the likelihood of the viewing user returning to the online system 140 after being presented with the landing page for less than the threshold amount of time after receiving the request. If the content item includes targeting criteria, when the online system 140 identifies 325 the opportunity to present content to the viewing user, the online system 140 determines 330 the likelihood of the viewing user returning to the online system 140 after being presented with the landing page for less than the threshold amount of time if characteristics of the viewing user satisfy at least a threshold amount of the targeting criteria included in the content item.

Based on a comparison of the likelihood of the viewing user returning to the online system 140 after being presented with the landing page for less than the threshold amount of time to the average likelihood of users returning to the online system 140 after being presented with the landing page for less than the threshold amount of time, the online system 140 determines 335 a measure of quality of the content item to the viewing user. If the comparison indicates the likelihood of the viewing user returning to the online system 140 after being presented with the landing page for less than the threshold amount of time is greater than the average likelihood of users returning to the online system after being presented with the landing page for less than the threshold amount of time, the measure of quality is relatively higher than if the comparison indicates the likelihood of the viewing user returning to the online system 140 after being presented with the landing page for less than the threshold amount of time is less than the average likelihood of users returning to the online system after being presented with the landing page for less than the threshold amount of time. For example, the online system 140 determines 335 the measure of quality based on various criteria and decreases the measure of quality if the comparison indicates the likelihood of the viewing user returning to the online system 140 after being presented with the landing page for less than the threshold amount of time is greater than the average likelihood of users returning to the online system after being presented with the landing page for less than the threshold amount of time. Conversely, in the preceding example, the measure of quality is increased if the comparison indicates the likelihood of the viewing user returning to the online system 140 after being presented with the landing page for less than the threshold amount of time is less than the average likelihood of users returning to the online system after being presented with the landing page for less than the threshold amount of time.

In various embodiments, the online system 140 determines a difference between the likelihood of the viewing user returning to the online system 140 after being presented with the landing page for less than the threshold amount of time and the average likelihood of users returning to the online system after being presented with the landing page for less than the threshold amount of time. Based on the determined difference, the online system 140 determines 335 the measure of quality of the content item to the viewing user. In various embodiments, the measure of quality is inversely related to the determined difference. Hence, as the difference between the likelihood of the viewing user returning to the online system 140 after being presented with the landing page for less than the threshold amount of time and the average likelihood of users returning to the online system after being presented with the landing page for less than the threshold amount of time increases, the measure of quality of the content item for the viewing user decreases. Conversely, as the difference between the likelihood of the viewing user returning to the online system 140 after being presented with the landing page for less than the threshold amount of time and the average likelihood of users returning to the online system after being presented with the landing page for less than the threshold amount of time decreases, the measure of quality of the content item for the viewing user increases. If the content item includes a bid amount, the online system 140 determines 335 the measure of quality of the content item for the viewing user by decreasing the bid amount included in the content item if the difference is greater than a threshold value; conversely, the online system 140 determines 335 the measure of quality of the content item for the viewing user by increasing the bid amount included in the content item if the difference is less than the threshold value. Hence, the online system 140 decreases the bid amount if the likelihood of the viewing user returning to the online system 140 after being presented with the landing page for less than the threshold amount of time is greater than the average likelihood and increases the bid amount if the likelihood of the viewing user returning to the online system 140 after being presented with the landing page for less than the threshold amount of time is less than the average likelihood. This allows the online system 140 to determine 335 the measure of quality of the content item for the viewing user by comparing the likelihood of the viewing user returning to the online system 140 after being presented with the landing page for less than the threshold amount of time and the average likelihood.

Alternatively, when determining 335 the measure of quality of the content item for the publishing user, the online system 140 determines a likelihood of the viewing user not returning to the online system 140 after being presented with the landing page for less than the threshold amount of time from the likelihood of the viewing user returning to the online system after being presented with the landing page for the threshold amount of time. The online system 140 subtracts the likelihood of the viewing user returning to the online system 140 after being presented with the landing page for less than the threshold amount of time from 100% to determine the likelihood of the viewing user not returning to the online system 140 after being presented with the landing page for at least the threshold amount of time. Similarly, the online system 140 determines an alternative average likelihood indicating a likelihood of the viewing user not returning to the online system 140 after being presented with the landing page for less than the threshold amount of time. The online system 140 determines the alternative average likelihood by subtracting the average likelihood of users returning to the online system 140 after being presented with the landing page for less than the threshold amount of time from 100%.

To determine 335 the measure of quality of the content item for the viewing user, the online system 140 compares the likelihood of the viewing user not returning to the online system 140 after being presented with the landing page for at least the threshold amount of time to the alternative average likelihood. If the likelihood of the viewing user not returning to the online system 140 after being presented with the landing page for at least the threshold amount of time exceeds the alternative average likelihood, the online system 140 increases the measure of quality of the content item to the viewing user. Conversely, if the likelihood of the viewing user not returning to the online system 140 after being presented with the landing page for at least the threshold amount of time is less than the alternative average likelihood, the online system 140 decreases the measure of quality of the content item for the viewing user. For example, the online system 140 determines a difference between the likelihood of the viewing user not returning to the online system 140 after being presented with the landing page for less than the threshold amount of time and the alternative average likelihood and modifies the measure of quality of the content item for the viewing user based on the difference. If the content item includes a bid amount, the online system 140 scales the bid amount a value based on the difference between the likelihood of the viewing user not returning to the online system 140 after being presented with the landing page for less than the threshold amount of time and the alternative average likelihood in some embodiments. Alternatively, the online system 140 increases the bid amount included in the content item if the difference between the likelihood of the viewing user not returning to the online system 140 after being presented with the landing page for less than the threshold amount of time and the alternative average likelihood equals or exceeds a threshold value; conversely, the online system 140 decreases the bid amount included in the content item if the difference between the likelihood of the viewing user not returning to the online system 140 after being presented with the landing page for less than the threshold amount of time and the alternative average likelihood is less than the threshold value. Hence, if the viewing user is more likely to not return to the online system 140 after being presented with the landing page for less than the threshold amount of time than an average user, the measure of quality of the content item to the viewing user is relatively higher.

The online system 140 includes 340 the content item in association with its measure of quality for the viewing user in one or more selection processes that select content for presentation to the viewing user via the identified opportunity. The one or more selection processes rank content items based on their associated measures of relevance and selects content items having at least a threshold position in the ranking for presentation to the viewing user via the identified opportunity. For example, if the content item includes a bid amount, the online system 140 modifies the bid amount based on the likelihood of the viewing user returning to the online system 140 after being presented with the landing page for less than the threshold amount of time (or based on the likelihood of the viewing user not returning to the online system 140 after being presented with the landing page for less than the threshold amount of time), and the one or more selection processes rank the content item based on its modified bid amounts and other content items based on their bid amounts. Hence, accounting for the likelihood of the viewing user returning to the online system 140 after being presented with the landing page for less than the threshold amount of time (or based on the likelihood of the viewing user not returning to the online system 140 after being presented with the landing page for less than the threshold amount of time) affects a likelihood of the one or more selection processes selecting the content item for presentation to the viewing user. This allows the content item to be presented to users of the online system 140 more likely to access or engage with the landing page identified by the content item, providing a greater benefit to the publishing user from presenting the content item via the online system 140.

### CONCLUSION

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving a content item at an online system, the content item including a link to a landing page that is in a domain differing from a domain of the online system;
obtaining a model determining a likelihood of a user of the online system who accesses the content item returning to the online system after being presented with the landing page for less than a threshold amount of time, the model based on characteristics of the user and characteristics of the landing page;
determining likelihoods of each of a plurality of users of the online system returning to the online system after being presented with the landing page for less than a threshold amount of time by applying the model to characteristics of each of the plurality of users of the online system;
determining an average likelihood of returning to the online system after being presented with the landing page for less than the threshold amount of time based on the determined likelihoods;
identifying an opportunity to present the content item to a viewing user of the online system;
determining a likelihood of the viewing user returning to the online system after being presented with the landing page for less than the threshold amount of time by applying the model to characteristics of the viewing user;
determining a measure of quality of the content item to the viewing user based on a comparison of the likelihood of the viewing user returning to the online system after being presented with the landing page for less than the threshold amount of time and the average likelihood; and
including the content item in association with the measure of quality in one or more selection processes selecting content for presentation to the viewing user via the opportunity based on measures of quality associated with content items.

2. The method of claim 1, wherein determining the measure of quality of the content item to the viewing user based on a comparison of the likelihood of the viewing user returning to the online system after being presented with the landing page for less than a threshold amount of time and the average likelihood comprises:
determining a difference between the likelihood of the viewing user returning to the online system after being presented with the landing page for less than a threshold amount of time and the average likelihood; and
determining the measure of quality of the content item as inversely related to the determined difference.

3. The method of claim 2, wherein determining the measure of quality of the content item as inversely related to the determined difference comprises:
reducing the measure of quality in response to the difference exceeding a threshold; and
increasing the measure of quality in response to the different being less than the threshold.

4. The method of claim 1, wherein the content item further includes a bid amount specifying an amount of compensation received by the online system in exchange for presenting the content item.

5. The method of claim 4, wherein determining the measure of quality of the content item to the viewing user based on the comparison of the likelihood of the viewing user returning to the online system after being presented with the landing page for less than the threshold amount of time and the average likelihood comprises:
increasing the bid amount included in the content item in response to the comparison indicating the likelihood of the viewing user returning to the online system after being presented with the landing page for less than the threshold amount of time is less than the average likelihood; and
decreasing the bid amount included in the content item in response to the comparison indicating the likelihood of the viewing user returning to the online system after being presented with the landing page for less than the threshold amount of time is greater than the average likelihood.

6. The method of claim 4, wherein determining the measure of quality of the content item to the viewing user based on the comparison of the likelihood of the viewing user returning to the online system after being presented with the landing page for less than the threshold amount of time and the average likelihood comprises:
determining a likelihood of the viewing user not returning to the online system after being presented with the landing page for less than the threshold amount of time from the likelihood of the viewing user returning to the online system after being presented with the landing page;
determining an alternative average likelihood of the viewing user not returning to the online system after being presented with the landing page for less than the threshold amount of time from the likelihood of the viewing user returning to the online system after being presented with the landing page from the average likelihood; and
modifying the bid amount included in the content item based on a difference between the likelihood of the viewing user not returning to the online system after being presented with the landing page for less than the threshold amount of time and the alternative average likelihood.

7. The method of claim 6, wherein modifying the bid amount included in the content item based on a difference between the likelihood of the viewing user not returning to the online system after being presented with the landing page for less than the threshold amount of time and the alternative average likelihood comprises:
scaling the bid amount included in the content item by a value based on the difference between the likelihood of the viewing user not returning to the online system after being presented with the landing page for less than the threshold amount of time and the alternative average likelihood.

8. The method of claim 1, wherein determining the measure of quality of the content item to the viewing user based on the comparison of the likelihood of the viewing user returning to the online system after being presented with the landing page for less than the threshold amount of time and the average likelihood comprises:
determining a likelihood of the viewing user not returning to the online system after being presented with the landing page for less than the threshold amount of time from the likelihood of the viewing user returning to the online system after being presented with the landing page;
determining an alternative average likelihood of the viewing user not returning to the online system after being presented with the landing page for less than the threshold amount of time from the likelihood of the viewing user returning to the online system after being presented with the landing page from the average likelihood; and
determining the measure of quality of the content item to the viewing user based on a difference between the likelihood of the viewing user not returning to the online system after being presented with the landing page for less than the threshold amount of time and the alternative average likelihood.

9. The method of claim 1, wherein the landing page comprises a web page in the domain differing from the domain of the online system.

10. The method of claim 1, wherein the threshold amount of time is based on a type of content included in the landing page.

11. A computer program product comprising a non-transitory computer readable medium having instructions encoded thereon that, when executed by a processor, cause the processor to:
receive a content item at an online system, the content item including a link to a landing page that is in a domain differing from a domain of the online system;
obtain a model determining a likelihood of a user of the online system who accesses the content item returning to the online system after being presented with the landing page for less than a threshold amount of time, the model based on characteristics of the user and characteristics of the landing page;
determine likelihoods of each of a plurality of users of the online system returning to the online system after being presented with the landing page for less than a threshold amount of time by applying the model to characteristics of each of the plurality of users of the online system;
determine an average likelihood of returning to the online system after being presented with the landing page for less than the threshold amount of time based on the determined likelihoods;
identify an opportunity to present the content item to a viewing user of the online system;
determine a likelihood of the viewing user returning to the online system after being presented with the landing page for less than the threshold amount of time by applying the model to characteristics of the viewing user;
determine a measure of quality of the content item to the viewing user based on a comparison of the likelihood of the viewing user returning to the online system after being presented with the landing page for less than the threshold amount of time and the average likelihood; and
include the content item in association with the measure of quality in one or more selection processes selecting content for presentation to the viewing user via the opportunity based on measures of quality associated with content items.

12. The computer program product of claim 11, wherein determine the measure of quality of the content item to the viewing user based on a comparison of the likelihood of the viewing user returning to the online system after being presented with the landing page for less than a threshold amount of time and the average likelihood comprises:
determine a difference between the likelihood of the viewing user returning to the online system after being presented with the landing page for less than a threshold amount of time and the average likelihood; and
determine the measure of quality of the content item as inversely related to the determined difference.

13. The computer program product of claim 12, wherein determine the measure of quality of the content item as inversely related to the determined difference comprises:
reduce the measure of quality in response to the difference exceeding a threshold; and
increase the measure of quality in response to the different being less than the threshold.

14. The computer program product of claim 11, wherein the content item further includes a bid amount specifying an amount of compensation received by the online system in exchange for presenting the content item.

15. The computer program product of claim 14, wherein determine the measure of quality of the content item to the viewing user based on the comparison of the likelihood of the viewing user returning to the online system after being presented with the landing page for less than the threshold amount of time and the average likelihood comprises:
increase the bid amount included in the content item in response to the comparison indicating the likelihood of the viewing user returning to the online system after being presented with the landing page for less than the threshold amount of time is less than the average likelihood; and
decrease the bid amount included in the content item in response to the comparison indicating the likelihood of the viewing user returning to the online system after being presented with the landing page for less than the threshold amount of time is greater than the average likelihood.

16. The computer program product of claim 14, wherein determine the measure of quality of the content item to the viewing user based on the comparison of the likelihood of the viewing user returning to the online system after being presented with the landing page for less than the threshold amount of time and the average likelihood comprises:
determine a likelihood of the viewing user not returning to the online system after being presented with the landing page for less than the threshold amount of time from the likelihood of the viewing user returning to the online system after being presented with the landing page;
determine an alternative average likelihood of the viewing user not returning to the online system after being presented with the landing page for less than the threshold amount of time from the likelihood of the viewing user returning to the online system after being presented with the landing page from the average likelihood; and
modify the bid amount included in the content item based on a difference between the likelihood of the viewing user not returning to the online system after being presented with the landing page for less than the threshold amount of time and the alternative average likelihood.

17. The computer program product of claim 16, wherein modify the bid amount included in the content item based on a difference between the likelihood of the viewing user not returning to the online system after being presented with the landing page for less than the threshold amount of time and the alternative average likelihood comprises:
scale the bid amount included in the content item by a value based on the difference between the likelihood of the viewing user not returning to the online system after being presented with the landing page for less than the threshold amount of time and the alternative average likelihood.

18. The computer program product of claim 11, wherein determine the measure of quality of the content item to the viewing user based on the comparison of the likelihood of the viewing user returning to the online system after being presented with the landing page for less than the threshold amount of time and the average likelihood comprises:
determine a likelihood of the viewing user not returning to the online system after being presented with the landing page for less than the threshold amount of time from the likelihood of the viewing user returning to the online system after being presented with the landing page;
determine an alternative average likelihood of the viewing user not returning to the online system after being presented with the landing page for less than the threshold amount of time from the likelihood of the viewing user returning to the online system after being presented with the landing page from the average likelihood; and
determine the measure of quality of the content item to the viewing user based on a difference between the likelihood of the viewing user not returning to the online system after being presented with the landing page for less than the threshold amount of time and the alternative average likelihood.

19. The computer program product of claim 11, wherein the landing page comprises a web page in the domain differing from the domain of the online system.

20. The computer program product of claim 11, wherein the threshold amount of time is based on a type of content included in the landing page.
